(19) United States
(12) Patent Application Publication
(10) Pub. No.: US 2012/0068976 A1
(43) Pub. Date: Mar. 22, 2012

(54) COMPOSITE DISPLAY DEVICE AND METHOD FOR CONTROLLING DISPLAY OPERATION OF THE SAME

(75) Inventor: Yao-Tsung Chang, New Taipei City (TW)

(73) Assignee: WISTRON CORPORATION, New Taipei City (TW)

(21) Appl. No.: 13/228,403

(22) Filed: Sep. 8, 2011

(30) Foreign Application Priority Data
Sep. 21, 2010 (TW) 099132030

(51) Int. Cl. G09G 5/00

(52) U.S. Cl. 345/204

(57) ABSTRACT

A composite display device includes a control unit, and first and second display units. The first display unit is coupled electrically to the control unit for displaying a first frame under control of the control unit. The second display unit is disposed beneath the first display unit, is coupled electrically to the control unit for displaying a second frame under control of the control unit, and has a refresh rate greater than that of the first display unit. The first display unit has a first display region that overlaps at least a portion of the second display unit and that is operable to permit the second frame to be visible therethrough under control of the control unit.

### CROSS-REFERENCE TO RELATED APPLICATION

This application claims priority of Taiwanese Application No. 099132030, filed on Sep. 21, 2010.

### BACKGROUND OF THE INVENTION

1. Field of the Invention

The invention relates to a display device and a control method thereof, more particularly to a composite display device and a method for controlling display operation of the same.

2. Description of the Related Art

Flat panel display (FPD) has the features of being lightweight, power-saving and having low radiation, and is therefore widely used in computer monitors, mobile phones, personal digital assistants (PDAs), flat panel televisions, multimedia consumer electronics, etc. In recent years, a new type of portable, lightweight and flexible display device has been introduced, called electronic paper (E-Paper) or electrophoretic display (EPD). However, the electronic paper has a refresh rate of approximately 200˜300 ms per frame, which when compared with the 60˜120 frames per second refresh rate of a liquid crystal display (LCD) makes the electronic paper better suitable for static displays (e.g., electronic books (E-Books)) and less suitable for web browsing.

Generally speaking, since electronic books are downloaded from Internet websites, a conventional e-book reader device (e-reader) 90 normally includes an electronic paper 91 for displaying e-books, and a liquid crystal display 92 disposed on the same plane as the electronic paper 91 for web browsing purposes to enable user search and downloads of desired e-book contents. Due to the desirably compact size of the conventional e-book reader device 90, in the presence of the liquid crystal display 92, the space available for the electronic paper 91 is fairly limited, thereby compromising convenience during e-book reading.

### SUMMARY OF THE INVENTION

Therefore, the object of the present invention is to provide a composite display device that can eliminate the aforesaid drawbacks of the prior art.

According to the pre sent invention, there is provided a composite display device that includes a control unit, and first and second display units.

The first display unit is coupled electrically to the control unit for displaying a first frame under control of the control unit.

The second display unit is disposed beneath the first display unit, is coupled electrically to the control unit for displaying a second frame under control of the control unit, and has a refresh rate greater than that of the first display unit.

The first display unit has a first display region that overlaps at least a portion of the second display unit and that is operable to permit the second frame to be visible therethrough under control of the control unit.

Another object of the present invention is to provide a method for controlling display operation of the composite display device, where the first display unit further has a second display region adjacent to the first display region, an entire display region of the second display unit has an area that is smaller than a combined area of the first and second regions of the first display unit, and the first display region of the first display unit overlaps the entire display region of the second display unit. The method includes the step of controlling the composite display device to operate in first, second or third mode upon receipt of a corresponding first, second or third display mode control signal. In the first mode, the entire display region of the second display unit is enabled to display the second frame, the first display region of the first display unit permits the second frame to be visible therethrough, and the second display region of the first display unit is disabled. In the second mode, the second display unit is disabled, and the first and second display regions of the first display unit are enabled to cooperatively display the first frame. In the third mode, the entire display region of the second display unit is enabled to display the second frame, the first display region of the first display unit permits the second frame to be visible therethrough, and the second display region of the first display unit is enabled to display the first frame.

Still another object of the present invention is to provide a method for controlling display operation of the composite display device, where an entire display region of the second display unit has an area that is substantially identical to that of the first display region of the first display unit, the first display region spans an entire display region of the first display unit and overlaps the entire display region of the second display unit, the first display region is divided into a first section and a second section, and the entire display region of the second display unit is divided into a third section and a fourth section respectively disposed beneath the first and second sections. The method includes the step of controlling the composite display device to operate in first, second and third modes upon receipt of first, second and third display mode control signals, respectively. In the first mode, the second display unit is enabled to display the second frame, and the first display region of the first display unit permits the second frame to be visible therethrough. In the second mode, the second display unit is disabled, and the first display region of the first display unit is enabled to display the first frame. In the third mode, the third section is enabled to display the second frame, the fourth section is disabled, the first section permits the second frame to be visible therethrough, and the second section is enabled to display the first frame.

Through the above design, since the second display unit is disposed beneath the first display unit, and the first display region of the first display unit permits the second frame displayed on the second display unit to be visible therethrough, the entire display region of the first display unit is not limited by the presence of the second display unit, and when the second display unit is disabled, the entire display region of the first display unit can be put into use for displaying the first frame, thereby facilitating convenient use of the composite display device.

### BRIEF DESCRIPTION OF THE DRAWINGS

Other features and advantages of the present invention will become apparent in the following detailed description of the embodiments with reference to the accompanying drawings, of which:

FIG. 1 is a schematic diagram, illustrating a conventional e-book reader device (E-Reader);

FIG. 2 is a block diagram, illustrating the first embodiment of a composite display device according to the present invention;

FIG. 3 is a perspective schematic diagram of a display module of the composite display device according to the first embodiment;

FIG. 4 is a perspective schematic diagram of the display module according to the second embodiment of a composite display device of the present invention;

FIG. 5 is a flow chart, illustrating a method for controlling display operation of a composite display device according to the first embodiment; and

FIG. 6 is a flow chart, illustrating a method for controlling display operation of a composite display device according to the second embodiment.

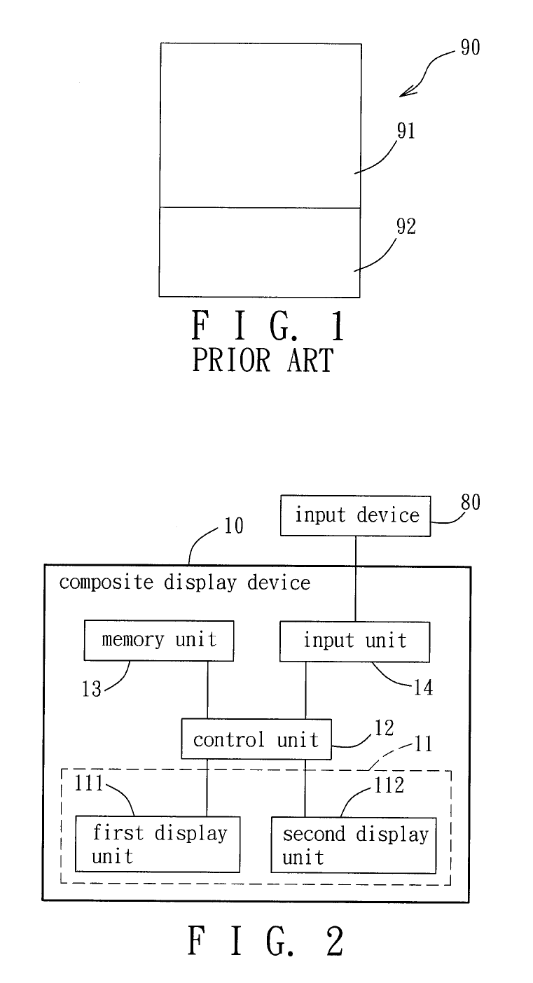

### DETAILED DESCRIPTION OF THE PREFERRED EMBODIMENTS

Before the present invention is described in greater detail, it should be noted that like elements are denoted by the same reference numerals throughout the disclosure.

With reference to FIG. 2 and FIG. 3, the first embodiment of a composite display device 10 according to the present invention includes a display module 11, a control unit 12, a memory unit 13 and an input unit 14. The display module 11 includes a first display unit 111 and a second display unit 112.

The first display unit 111 is coupled electrically to the control unit 12 for displaying a first frame under control of the control unit 12. The second display unit 112 is disposed beneath the first display unit 111, is coupled electrically to the control unit 12 for displaying a second frame under control of the control unit 12, and has a refresh rate greater than that of the first display unit 111.

The memory unit 13 is coupled electrically to the control unit 12 for storing control data necessary for operations of the control unit 12, and for storing data corresponding to the first and second frames. The memory unit 13 may include a non-volatile memory and/or a volatile memory. The input unit 14 is coupled electrically to the control unit 12 for inputting a control signal to the control unit 12. The control unit 12 controls operations of the first and second display units 111, 112 according to the control signal. The input unit 14 may be coupled to an input device 80 which may be any of a keyboard, a mouse, a button, a touch control device or a combination thereof for generating the control signal.

The first display unit 111 may be an electronic paper, and the second display unit 112 may be any of a liquid crystal display (LCD), a light-emitting diode (LED) display or an organic light-emitting diode (OLED) display. The first display unit 111 has a first display region (D1) that overlaps at least a portion of the second display unit 112 and that is operable to permit the second frame to be visible therethrough under control of the control unit 12.

In this embodiment, the first display unit 111 further has a second display region (D2) adjacent to the first display region (D1), and an entire display region of the second display unit 112 has an area that is smaller than a combined area of the first and second regions (D1, D2) of the first display unit 111. A long edge of the second display unit 112 is aligned with a short edge of the first display unit 111, and the first display region (D1) of the first display unit 111 overlaps the entire display region of the second display unit 112.

The composite display device 10 is operable in three different modes, namely a first mode, a second mode and a third mode.

When the composite display device 10 operates in the first mode, under control of the control unit 12, the entire display region of the second display unit 112 is enabled to display the second frame, the first display region (D1) of the first display unit 111 permits the second frame to be visible therethrough, and the second display region (D2) of the first display unit 111 is disabled. Under this mode, pixels in the second display region (D2) are disabled as the first frame is not displayed so as to save power while the second frame can be viewed through the first display region (D1).

When the composite display device 10 operates in the second mode, under control of the control unit 12, the second display unit 112 is disabled, and the first and second display regions (D1, D2) of the first display unit 111 are enabled to cooperatively display the first frame. In this mode, only the first frame is displayed.

When the composite display device 10 operates in the third mode, under control of the control unit 12, the entire display region of the second display unit 112 is enabled to display the second frame, the first display region (D1) of the first display unit 111 permits the second frame to be visible therethrough, and the second display region (D2) of the first display unit 111 is enabled to display the first frame, such that the first and second frames are simultaneously displayed on the composite display device 10.

During operation of the composite display device 10, the second display unit 112 with the greater refresh rate can be used for web browsing purposes under the first and third modes in order for a user to search and download data from the Internet, and can be disabled under the second mode to save power while the entire display region of the first display unit 111 as constituted by the first and second display regions (D1, D2) is used for displaying the first frame according to the data thus acquired through downloading. In this case, the memory unit 13 is for storing the control data necessary for control of the first and second display units 111, 112 by the control unit 12 under each of the first, second and third modes, and for storing the data downloaded from the Internet and corresponding to the first frame, as well as temporarily storing web pages corresponding to the second frame on the second display unit 112.

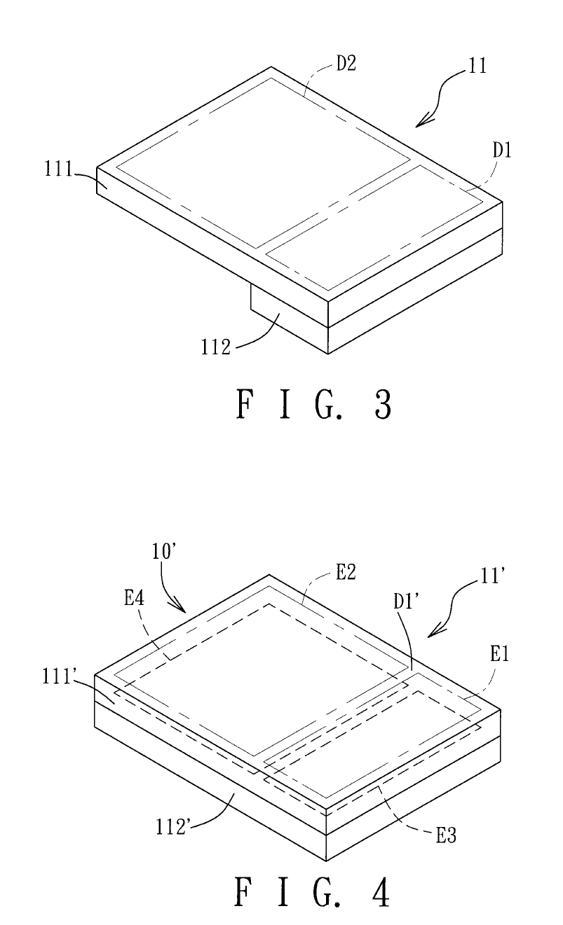

With reference to FIG. 4, the second embodiment of a composite display device 10′ according to the present invention differs from the first embodiment in the arrangement of the display module 11′, where the entire display region of the second display unit 112′ according to the second embodiment has an area that is substantially identical to that of the first display region (D1′) of the first display unit 111′. Specifically, the first display region (D1′) of the first display unit 111′ spans an entire display region of the first display unit 111′, and overlaps the entire display region of the second display unit 112′. The first display region (D1′) of the first display unit 111′ is divided into a first section (E1) and a second section (E2), and the entire display region of the second display unit 112′ is divided into a third section (E3) and a fourth section (E4) respectively disposed beneath the first and second sections (E1, E2) of the first display unit 111′.

As with the previous embodiment, the composite display device 10′ is operable in three different modes, a first mode, a second mode and a third mode.

When operating in the first mode, under control of the control unit 12 (as shown in FIG. 2), the second display unit 112′ is enabled to display the second frame, and the first display region (D1′) of the first display unit 111′ permits the second frame to be visible therethrough. In this mode, only the second frame is displayed.

When the composite display device 10′ operates in the second mode, under control of the control unit 12, the second display unit 112′ is disabled, and the first display region (D1′) of the first display unit 111′ is enabled to display the first frame. In this mode, only the first frame is displayed.

When the composite display device 10′ operates in the third mode, under control of the control unit 12, the third section (E3) of the second display unit 112′ is enabled to display the second frame, the fourth section (E4) of the second display unit 112′ is disabled, the first section (E1) of the first display unit 111′ permits the second frame to be visible therethrough, and the second section (E2) of the first display unit 111′ is enabled to display the first frame. In other words, the entire display region of the composite display device 10′ as a whole is divided into two sections for respectively and simultaneously displaying the first and second frames.

According to the second embodiment, during operation of the composite display device 10′, since the entire display region (i.e., the first display region (D1′)) of the first display unit 111′ is operable in the first mode to permit the user to view therethrough the second frame displayed on the second display unit 112′, the size of display region of which is the same as that of the first display unit 111′, the entire display region of the composite display device 10′ as a whole can be used when web browsing is desired. Once desired data is acquired from the Internet under the first mode, the composite display device 10′ may be switched to operate in the second mode so as to allow display of the first frame according to the acquired data using the entire display region of the composite display device 10′ as a whole, while the second display unit 112′ is disabled to save power. Alternatively, when operation is switched to the third mode, the entire display region of the composite display device 10′ may be divided into two parts, one for displaying the second frame for web browsing, and the other for displaying the first frame to view downloaded data.

In view of the above disclosure, the method for controlling display operation of a composite display device 10 includes the steps of controlling a first display unit 111 to display a first frame, controlling a second display unit 112 that is disposed beneath the first display unit 111 and that has a refresh rate greater than that of the first display unit 111 to display a second frame, and controlling a first display region (D1) of the first display unit 111 that overlaps at least a portion of the second display unit 112 to permit the second frame to be visible therethrough.

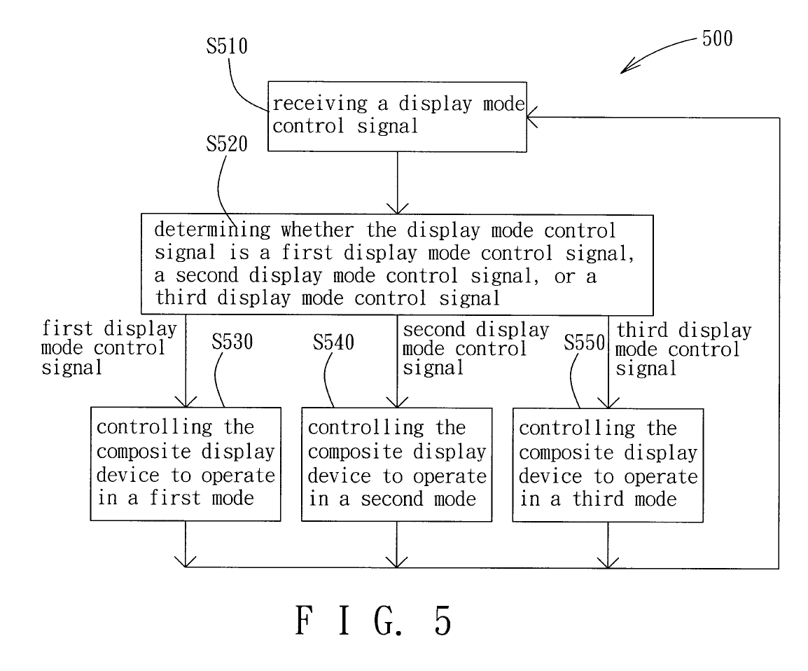

With reference to FIG. 5, the method 500 for controlling display operation of the composite display device 10 according to the first embodiment of the present invention includes the following steps. To recap, according to the first embodiment, the first display unit 111 of the composite display device 10 has adjacent first and second display regions (D1, D2), where the first display region (D1) overlaps the entire display region of the second display unit 112.

After power is supplied to the composite display device 10 to enable operation thereof, upon receipt of a display mode control signal (step S510), the control unit 12 of the composite display device 10 determines whether the display mode control signal is a first display mode control signal, a second display mode control signal, or a third display mode control signal (step S520) in order to decide whether to proceed to steps S530, S540 or S550.

If it is determined in step S520 that the display mode control signal is the first display mode control signal, the flow goes to step S530, in which the composite display device 10 is controlled to operate in a first mode, where the entire display region of the second display unit 112 is enabled to display the second frame, the first display region (D1) of the first display unit 111 is controlled to permit the second frame to be visible therethrough, and the second display region (D2) of the first display unit 111 is disabled.

If it is determined in step S520 that the display mode control signal is the second display mode control signal, the flow goes to step S540, in which the composite display device 10 is controlled to operate in a second mode, where the second display unit 112 is disabled, and the first and second display regions (D1, D2) of the first display unit 111 are enabled to cooperatively display the first frame.

If it is determined in step S520 that the display mode control signal is the third display mode control signal, the flow goes to step S550, in which the composite display device 10 is controlled to operate in a third mode, where the entire display region of the second display unit 112 is enabled to display the second frame, the first display region (D1′) of the first display unit 111 is controlled to permit the second frame to be visible therethrough, and the second display region (D2) of the first display unit 111 is enabled to display the first frame.

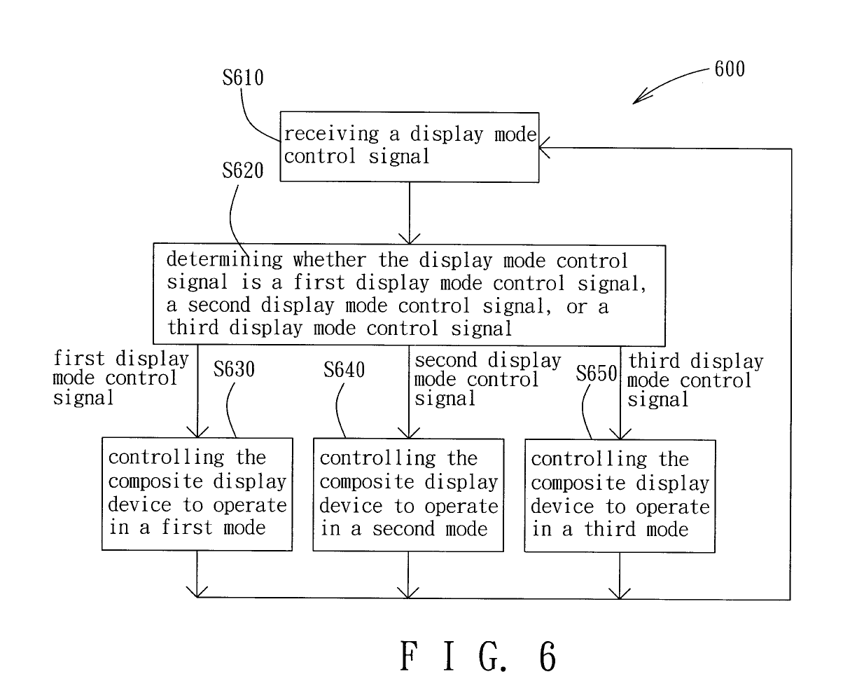

With reference to FIG. 6, the method 600 for controlling display operation of the composite display device 10′ according to the second embodiment of the present invention includes the following steps. To recap, according to the second embodiment, the entire display region of the second display unit 112′ has an area that is substantially identical to that of the first display region (D1′) of the first display unit 111′, which spans an entire display region of the first display unit 111′ and overlaps the entire display region of the second display unit 112′. In addition, the first display region (D1′) is divided into the first and second sections (E1, E2), while the entire display region of the second display unit 112′ is divided into the third and fourth sections (E3, E4) respectively disposed beneath the first and second sections (E1, E2).

After power is supplied to the composite display device 10′ to enable operation thereof, upon receipt of a display mode control signal (step S610), the control unit 12 of the composite display device 10′ determines whether the display mode control signal is a first display mode control signal, a second display mode control signal, or a third display mode control signal (step S620) in order to decide whether to proceed to steps S630, S640 or S650.

If it is determined in step S620 that the display mode control signal is the first display mode control signal, the flow goes to step S630, in which the composite display device 10′ is controlled to operate in a first mode, where the second display unit 112′ is enabled to display the second frame, and the first display region (D1′) of the first display unit 111′ is controlled to permit the second frame to be visible therethrough.

If it is determined in step S620 that the display mode control signal is the second display mode control signal, the flow goes to step S640, in which the composite display device 10′ is controlled to operate in a second mode, where the second display unit 112′ is disabled, and the first display region (D1′) of the first display unit 111′ is enabled to display the first frame.

If it is determined in step S620 that the display mode control signal is the third display mode control signal, the flow goes to step S650, in which the composite display device 10′ is controlled to operate in a third mode, where the third section (E3) of the second display unit 112′ is enabled to display the second frame, the fourth section (E4) of the second display unit 112′ is disabled, the first section (E1) of the first display unit 111′ is controlled to permit the second frame to be visible therethrough, and the second section (E2) of the first display unit 111′ is enabled to display the first frame.

In summary, since the second display unit 112, 112′ is disposed beneath the first display unit 111, 111′, and since the second frame displayed on the second display unit 112, 112′ is visible through the first display region (D1) of the first display unit 111, 111′, the presence of the second display unit 112, 112′ does not adversely affect, in particular reduce, the space available for the first display unit 111, 111′, such that when viewing of the second frame is not required, the composite display device 10, 10′ may be operated to permit display of the first frame using the entire display region of the first display unit 111, 111′, thus the entire display region of the composite display device 10, 10′, to facilitate convenient viewing of the first frame by the user.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A composite display device comprising:
a control unit;
a first display unit coupled electrically to said control unit for displaying a first frame under control of said control unit; and
a second display unit disposed beneath said first display unit, coupled electrically to said control unit for displaying a second frame under control of said control unit, and having a refresh rate greater than that of said first display unit;
wherein said first display unit has a first display region that overlaps at least a portion of said second display unit and that is operable to permit the second frame to be visible therethrough under control of said control unit.

2. The composite display device as claimed in claim 1, further comprising a memory unit coupled electrically to said control unit for storing control data necessary for operation of said control unit, and for storing data corresponding to the first and second frames.

3. The composite display device as claimed in claim 1, further comprising an input unit coupled electrically to said control unit for inputting a control signal to said control unit, said control unit controlling operations of said first and second display units according to the control signal.

4. The composite display device as claimed in claim 1, wherein said first display unit further has a second display region adjacent to said first display region, and an entire display region of said second display unit has an area that is smaller than a combined area of said first and second regions of said first display unit.

5. The composite display device as claimed in claim 4, wherein:
said first display region of said first display unit overlaps the entire display region of said second display unit; and
said composite display device is operable in a first mode, where under control of said control unit, the entire display region of said second display unit is enabled to display the second frame, said first display region of said first display unit permits the second frame to be visible therethrough, and said second display region of said first display unit is disabled.

6. The composite display device as claimed in claim 5, wherein said composite display device is further operable in a second mode, where under control of said control unit, said second display unit is disabled, and said first and second display regions of said first display unit are enabled to cooperatively display the first frame.

7. The composite display device as claimed in claim 6, wherein said composite display device is further operable in a third mode, where under control of said control unit, the entire display region of said second display unit is enabled to display the second frame, said first display region of said first display unit permits the second frame to be visible therethrough, and said second display region of said first display unit is enabled to display the first frame.

8. The composite display device as claimed in claim 1, wherein an entire display region of said second display unit has an area that is substantially identical to that of said first display region of said first display unit.

9. The composite display device as claimed in claim 8, wherein:
said first display region of said first display unit spans an entire display region thereof, and overlaps the entire display region of said second display unit; and
said composite display device is operable in a first mode, where under control of said control unit, said second display unit is enabled to display the second frame, and said first display region of said first display unit permits the second frame to be visible therethrough.

10. The composite display device as claimed in claim 9, wherein said composite display device is further operable in a second mode, where under control of said control unit, said second display unit is disabled, and said first display region of said first display unit is enabled to display the first frame.

11. The composite display device as claimed in claim 10, wherein:
said first display region of said first display unit is divided into a first section and a second section, and the entire display region of said second display unit is divided into a third section and a fourth section respectively disposed beneath said first and second sections; and
said composite display device is further operable in a third mode, where under control of said control unit, said third section is enabled to display the second frame, said fourth section is disabled, said first section permits the second frame to be visible therethrough, and said second section is enabled to display the first frame.

12. A method for controlling display operation of a composite display device, said method comprising the steps of:
controlling a first display unit to display a first frame;
controlling a second display unit that is disposed beneath said first display unit and that has a refresh rate greater than that of the first display unit to display a second frame; and
controlling a first display region of the first display unit that overlaps at least a portion of the second display unit to permit the second frame to be visible therethrough.

13. The method as claimed in claim 12, the first display unit further having a second display region adjacent to the first display region, an entire display region of the second display unit having an area that is smaller than a combined area of the first and second regions of the first display unit, the first display region of the first display unit overlapping the entire display region of said second display unit, said method further comprising the step of:
upon receipt of a first display mode control signal, controlling the composite display device to operate in a first mode, where the entire display region of the second display unit is enabled to display the second frame, the first display region of the first display unit is controlled to permit the second frame to be visible therethrough, and the second display region of the first display unit is disabled.

14. The method claimed in claim 13, further comprising the step of:
upon receipt of a second display mode control signal, controlling the composite display device to operate in a second mode, where the second display unit is disabled, and the first and second display regions of the first display unit are enabled to cooperatively display the first frame.

15. The method as claimed in claim 13, further comprising the step of:
upon receipt of a third display mode control signal, controlling the composite display device to operate in a third mode, where the entire display region of the second display unit is enabled to display the second frame, the first display region of the first display unit is controlled to permit the second frame to be visible therethrough, and the second display region of the first display unit is enabled to display the first frame.

16. The method as claimed in claim 12, an entire display region of the second display unit having an area that is substantially identical to that of the first display region of the first display unit, the first display region spanning an entire display region of the first display unit and overlapping the entire display region of the second display unit, said method further comprising the step of:
upon receipt of a first display mode control signal, controlling the composite display device to operate in a first mode, where the second display unit is enabled to display the second frame, and the first display region of the first display unit is controlled to permit the second frame to be visible therethrough.

17. The method as claimed in claim 16, further comprising the step of:
upon receipt of a second display mode control signal, controlling the composite display device to operate in a second mode, where the second display unit is disabled, and the first display region of the first display unit is enabled to display the first frame.

18. The method as claimed in claim 16, the first display region of the first display unit being divided into a first section and a second section, the entire display region of the second display unit being divided into a third section and a fourth section respectively disposed beneath the first and second sections, said method further comprising the step of:
upon receipt of a third display mode control signal, controlling the composite display device to operate in a third mode, where the third section is enabled to display the second frame, the fourth section is disabled, the first section is controlled to permit the second frame to be visible therethrough, and the second section is enabled to display the first frame.
